(19) United States
(12) Patent Application Publication
(10) Pub. No.: US 2013/0133693 A1
(43) Pub. Date: May 30, 2013

(54) Side Edge Cleaning Methods and Apparatus for Thin Film Photovoltaic Devices

(71) Applicants: Joe Hunter, Fort Collins, CO (US); Leonard L. Boyer, Arvada, CO (US); Robert A. Garber, Denver, CO (US); Donald F. Foust, Glenville, NY (US)

(72) Inventors: Joe Hunter, Fort Collins, CO (US); Leonard L. Boyer, Arvada, CO (US); Robert A. Garber, Denver, CO (US); Donald F. Foust, Glenville, NY (US)

(73) Assignee: PRIMESTAR SOLAR, INC., Arvada, CO (US)

(21) Appl. No.: 13/308,288

(22) Filed: Nov. 30, 2011

(51) Int. Cl. B08B 1/04; A47L 7/00; B08B 5/04

(52) U.S. Cl. 134/9; 134/122 R; 15/322

(57) ABSTRACT

Methods for cleaning a side edge of a thin film photovoltaic substrate are provided. A cleaning solution can be applied to a cleaning wheel that has a cleaning surface and is rotatable about an axis. The substrate can then be transported in a machine direction to move the substrate past the cleaning wheel such that the cleaning surface of the cleaning wheel contacts the side edge of the substrate allowing the cleaning solution to remove any thin film present on the side edge of the substrate. Apparatus is also generally provided for cleaning a side edge of a thin film photovoltaic substrate.

### FIELD OF THE INVENTION

The subject matter disclosed herein relates generally to cleaning the side edges of a thin film photovoltaic device. More particularly, the subject matter disclosed herein relates to methods and apparatus for removing materials deposited on the side edge of thin film photovoltaic device prior to finishing the device.

### BACKGROUND OF THE INVENTION

During deposition of a thin film on a substrate in the formation of a thin film photovoltaic device, the thin film material tends to deposit on unwanted areas of the substrate. This unwanted deposition can be particularly present when a vapor deposition process (e.g., a closed space sublimation process) is utilized to form the thin film layer on a face of the substrate. The thin film material can deposit and/or adhere to the side edges of the substrate (i.e., along the perimeter of the substrate, perpendicular or otherwise angled relative to the face) as well as on the face of the substrate. For example, when depositing cadmium telluride onto a photovoltaic substrate to form a photovoltaic absorber layer of a thin film photovoltaic device, cadmium telluride can also deposit onto the side edges of the substrate.

This unwanted deposition of thin film material on the substrate should be removed prior to completion of the device. For example, such thin film materials present on the side edges of the substrate, which collectively are sometimes referred to as the “pencil edge” of a given panel, should be removed prior to sealing of the photovoltaic device. Additionally, the thin film materials on the side edge should be removed to prevent it from exposure or release to the environment once the device is placed into service. For example, when dealing with cadmium telluride, it is desired that all of the cadmium telluride material be encased within the photovoltaic device to prevent release of cadmium into the environment. However, removal of the unwanted thin film material deposited on the side edge can be a delicate process, since the removal process should not otherwise alter or affect the thin film layer(s) on the face of the substrate.

Thus, a need exists for apparatus and methods for cleaning a side edge of a thin film photovoltaic device. In particular, a need exists for apparatus and methods for removing thin film materials from a side edge of a thin film photovoltaic substrate.

### BRIEF DESCRIPTION OF THE INVENTION

Aspects and advantages of the invention will be set forth in part in the following description, or may be obvious from the description, or may be learned through practice of the invention.

Methods are generally provided for cleaning a side edge of a thin film photovoltaic substrate. In one embodiment, a cleaning solution can be applied to a cleaning wheel that has a cleaning surface that is rotatable about an axis. The substrate can then be transported in a machine direction to move the substrate past the cleaning wheel such that the cleaning surface of the cleaning wheel contacts the side edge of the substrate allowing the cleaning solution to remove any thin film present on the side edge of the substrate.

The method can, in one embodiment, further include applying the cleaning solution to a second cleaning wheel that defines a second cleaning surface that is rotatable about a second axis. The substrate can be transported in a machine direction to move the substrate past the second cleaning wheel such that the second cleaning surface of the second cleaning wheel contacts the second side edge of the substrate allowing the cleaning solution to remove any thin film present on the second side edge of the substrate.

An apparatus is also generally provided for cleaning a side edge of a thin film photovoltaic substrate. In one embodiment, the apparatus can include a cleaning wheel rotatable about an axis and defining a cleaning surface; a source for a cleaning solution to be applied onto the cleaning surface of the cleaning wheel; and a transport mechanism. The transport mechanism is configured to move the substrate in a machine direction past the cleaning wheel such that the cleaning surface of the cleaning wheel contacts the side edge of the substrate to allow the cleaning solution to remove the thin film present on the side edge of the substrate.

In another embodiment, the apparatus can include a transport mechanism configured to move the substrate in a machine direction; a first bracket having a top spray nozzle and a bottom spray nozzle; a first supply line connected to the top spray nozzle and configured to supply a cleaning solution to the top spray nozzle; a second supply line connected to the bottom spray nozzle and configured to supply the cleaning solution to the bottom spray nozzle; and, a vacuum line connected to an evacuation opening in the first bracket between the top spray nozzle and the bottom spray nozzle. The vacuum line can be connected to a vacuum pump and can be configured to draw the cleaning solution to a first side edge of the substrate after the cleaning solution is sprayed from the top spray nozzle and the bottom spray nozzle. The first bracket can be positioned along the transport mechanism and can be configured to receive the first side edge between the top spray nozzle and the bottom spray nozzle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended figures, in which:

FIG. 1 shows a general schematic of one embodiment of an exemplary apparatus for removing material from side edges of a thin film photovoltaic device;

FIG. 2 shows a general schematic of a cross-sectional view of the apparatus of FIG. 1;

FIG. 3 shows a general schematic of another embodiment of an exemplary apparatus for removing material from side edges of a thin film photovoltaic device;

FIG. 4 shows a general schematic of a cross-sectional view of the apparatus of FIG. 3;

FIG. 5 shows a general schematic of yet another embodiment of an exemplary apparatus for removing material from side edges of a thin film photovoltaic device; and,

FIG. 6 shows a general schematic of a cross-sectional view of the apparatus of FIG. 5.

Repeat use of reference characters in the present specification and drawings is intended to represent the same or analogous features or elements.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In the present disclosure, when a layer is being described as “on” or “over” another layer or substrate, it is to be understood that the layers can either be directly contacting each other or have another layer or feature between the layers, unless otherwise stated. Thus, these terms are simply describing the relative position of the layers to each other and do not necessarily mean “on top of” since the relative position above or below depends upon the orientation of the device to the viewer. Additionally, although the invention is not limited to any particular film thickness, the term “thin” describing any film layers of the photovoltaic device generally refers to the film layer having a thickness less than about 10 micrometers (“microns” or “μm”).

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

Methods and apparatus are generally provided for cleaning a side edge of a photovoltaic substrate, with the side edge adjoining (e.g., being orthogonal or angled relative to) a face surface of the substrate. More particularly, the methods and apparatus described herein can remove thin film materials from the side edge of the substrate without substantially affecting the thin film layer on the face surface (e.g., the surface on which a thin film is deposited) in the active area of the resulting device. As such, any unwanted, extra thin film material deposited onto the side edge(s) of the substrate can be removed during processing of the thin film photovoltaic device, while maintaining the functionality of the thin film layers on the face surface of the substrate, at least not outside of the typical edge delete zone.

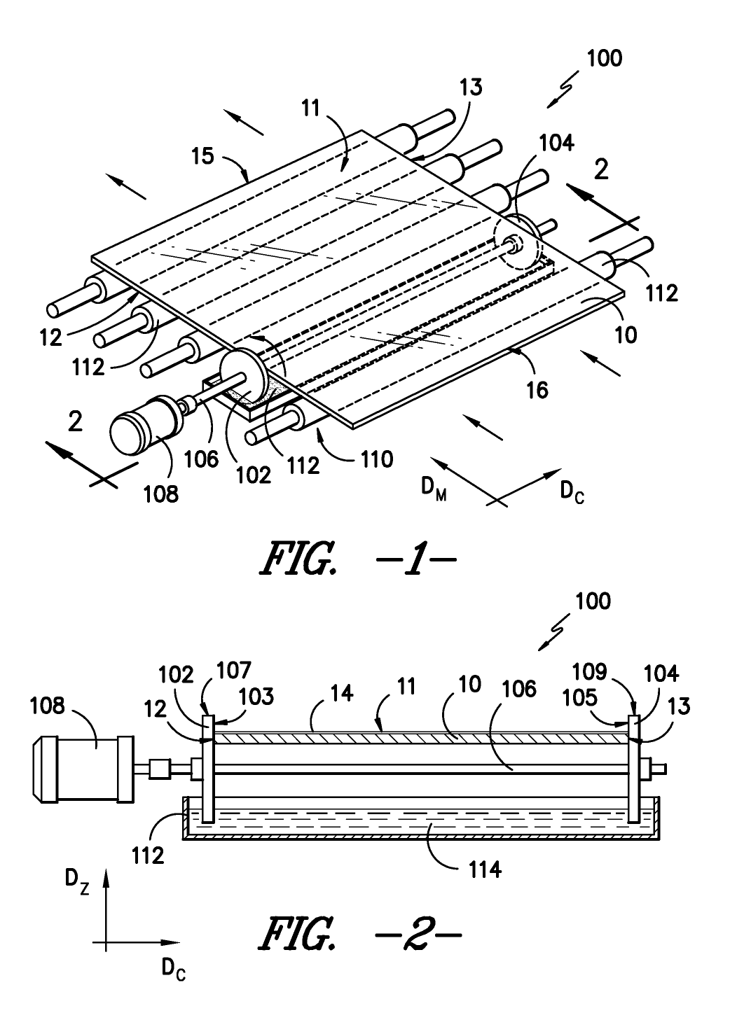

In one embodiment, the methods of cleaning a side edge of a thin film photovoltaic substrate can include applying a cleaning solution to a cleaning wheel that is rotatable about an axis. The substrate can be transported in a machine direction past the cleaning wheel such that a cleaning surface of the cleaning wheel contacts the side edge of the substrate. The cleaning solution can then remove (e.g., dissolve) the thin film present on the side edge of the substrate, with the side edge being, e.g., generally orthogonal to the face surface. As shown in FIG. 1, the facing surface 11 terminates at the first side edge 12 and the second side edge 13 in the cross-machine direction (D_{c}), and at the leading edge 15 and the trailing edge 16 in the machine direction (Dₘ).

FIGS. 1-2 show an exemplary apparatus 100 for cleaning a side edge 12, 13 of a thin film photovoltaic substrate 10 using a cleaning wheel 102. As shown, a first cleaning wheel 102 is positioned opposite of a second cleaning wheel 104 in the apparatus 100. A transport mechanism 110 that includes a series of rollers 112 is configured to move the substrate 10 in the machine direction Dₘ between the first cleaning wheel 102 and the second cleaning wheel 104. The first and second cleaning wheels 102, 104 are positioned relative to each other such that the substrate 10 passes therebetween with its first side edge 12 contacting the cleaning surface 103 of the first cleaning wheel 102 and its second side edge 13 contacting the cleaning surface 105 of the second cleaning wheel 104.

As shown, each of the cleaning wheels 102, 104 has a disk shape with the cleaning surface 103, 105 and an outer ring 107, 109, respectively. The cleaning wheels 102, 104 are oriented such that the cleaning surfaces 103, 105 contacts the side edges 12, 13, respectively, of the substrate 10.

The cleaning wheels 102, 104 are generally rotatable about an axis 106, which is oriented in the cross-machine direction D_{c} that is perpendicular to the machine direction Dₘ. For example, as shown in FIGS. 1 and 2, the cleaning surfaces 103, 105 can be oriented generally parallel to the side edges 12, 13 of the substrate. In one particular embodiment, the cleaning wheels 102, 104 can rotate about the axis 106 independent of the movement of the substrate 10, such that the cleaning surfaces 103, 105 rubs or otherwise abrades the side edges 12, 13, respectively, of the substrate 10. The wiping or rubbing of the side edges 12, 13 with the cleaning surfaces 103, 105, respectively, may also result in some abrasion of the side edges 12, 13, thus providing a mechanism of mechanical cleaning for the side edges 12, 13, in addition to the cleaning solution serving to chemically clean the side edges 12, 13.

As shown, a motor 108 can be attached to the axis 106 to rotate the cleaning wheels 102, 104 independent of the movement of the substrate 10 on the transport mechanism 110. However, in one embodiment, the movement of the substrates 10 through the apparatus 2100 can be enough to rotate the cleaning wheels 102, 104. It is to be understood that the independent movement could be, e.g., counter to the direction of movement of rollers 112 or in the same direction thereof but at a different speed, in order to facilitate the wiping action of the cleaning wheels 102, 104.

The cleaning wheels 102, 104 can rotate through a solution bath 112 to apply the cleaning solution 114 onto the cleaning wheels 102, 104. Thus, the solution bath 112 acts as a source for the cleaning solution 114. As such, the cleaning solution 114 can be present on the cleaning surfaces 103, 105 of the cleaning wheels 102, 104, respectively, to remove (e.g., solubilize, etch, or otherwise dissolve) the thin film 14 from the side edges 12, 13.

The cleaning surfaces 103, 105 of the cleaning wheels 102, 104, respectively, can be any suitable surface for cleaning, buffing, etching, etc. of the substrate 10, such as including but not limited to polytetrafluoroethylene, fiberglass, stainless steel, wool, a sponge or scoring material (e.g., Scotch-Brite® from 3M Corp.), etc., or combinations thereof

As stated, the transport mechanism 110 is configured to move the substrate 10 in a machine direction Dₘ past the cleaning wheels 102, 104 such that their cleaning surfaces 103, 105, respectively, contact the corresponding side edges 12, 13 of the substrate 10 to allow the cleaning solution 114 to remove any thin film 14 present on the side edges 12, 13 of the substrate 10. In one particular embodiment, the transport mechanism 110 can be configured to continuously move a plurality of substrates 10 between the cleaning wheels 102, 104, such as in a large scale manufacturing process. Accordingly, any thin film material 14 present on the side edges 12, 13 of each substrate 10 can be removed.

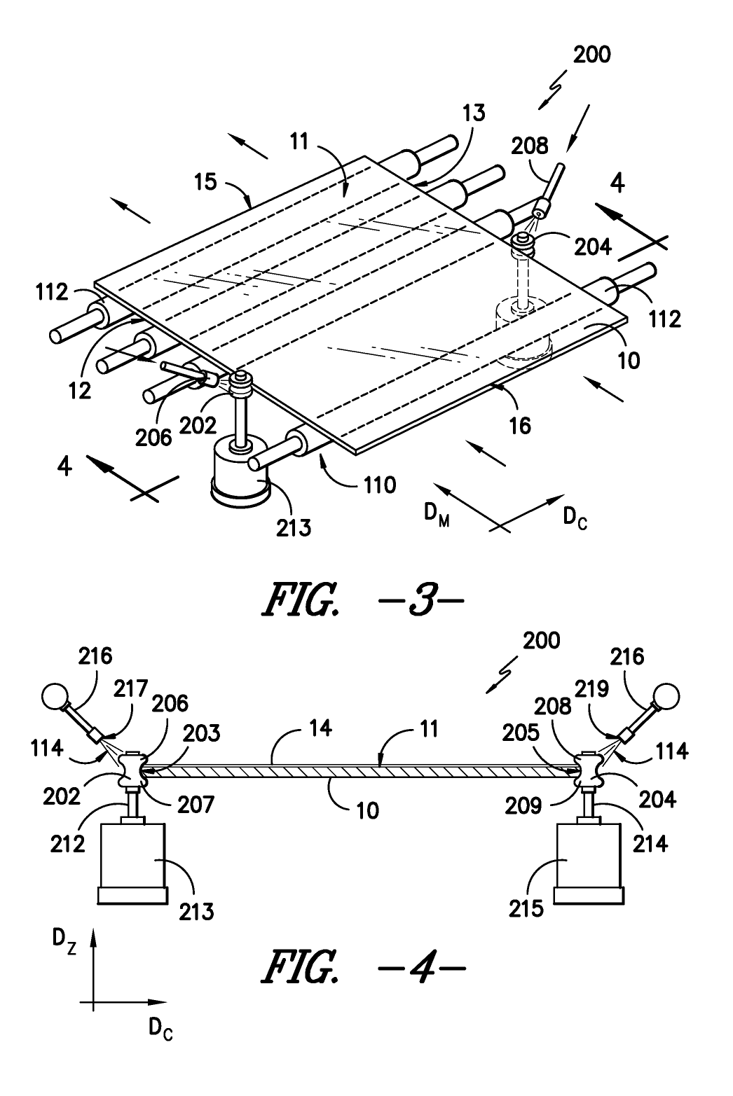

FIGS. 3-4 show another exemplary apparatus 200 for cleaning the side edge of a thin film photovoltaic substrate using a cleaning wheel. As shown, a first cleaning wheel 202 is positioned opposite of a second cleaning wheel 204 in the apparatus 200. A transport mechanism 110 that includes a series of rollers 112 is configured to move the substrate 10 in the machine direction Dₘ between the first cleaning wheel 202 and the second cleaning wheel 204. The first and second cleaning wheels 202, 204 are positioned relative to each other such that the substrate 10 passes therebetween with its first side edge 12 contacting the cleaning surface 203 of the first cleaning wheel 202 and its second side edge 13 contacting the cleaning surface 205 of the second cleaning wheel 204.

In this embodiment, the cleaning wheels 202, 204 are rotatable about the axis 212, 214, respectively, which are oriented in a z-direction D_{z} that is perpendicular to the machine direction Dₘ and to the crossmachine direction D_{c}. Thus, the cleaning wheels 202, 204 can rotate about the axis 212, 214, respectively, such that the cleaning surfaces 203, 205 either move with the substrate 10 (e.g., at the same speed or at a different speed) or move opposite thereof, depending on the amount of wiping and/or abrasion desired. Motors 213, 215 are shown connected to the axis 212, 214, respectively, to rotate the cleaning wheels 202, 204 independently of the movement on the substrates 10 through the apparatus 200. However, in one embodiment, the movement of the substrates 10 through the apparatus 200 can be enough to rotate the cleaning wheels 202, 204.

The respective cleaning surfaces 203, 205 of the cleaning wheels 202, 204 are generally located within a corresponding groove between a top ring 206, 207 and a bottom ring 208, 209 such that the side edges 12, 13 of the substrate 10, respectively fits therebetween to contact the cleaning surfaces 203, 205. In one embodiment, the cleaning wheels 202, 204 may be made of a compliant material, e.g., to promote sufficient contact between the cleaning surfaces 203, 205 and side edges 12, 13, respectively, as needed to achieve removal of any thin film material 14 thereon.

In one embodiment, the cleaning solution 114 can be applied to the cleaning wheels 202, 204 via spraying from a source. In the exemplary embodiment shown, the supply lines 216, 218 supply the cleaning solution 114 to nozzles 217, 219, respectively. The nozzles 217, 219 are oriented such that the cleaning solution 114 can be sprayed or otherwise applied onto the cleaning surfaces 203, 205 of the cleaning wheels 202, 204, respectively. As shown, the nozzles 217,219 spray the cleaning solution 114 onto the cleaning wheels 202,204 on the side opposite to where the substrate 10 is located, so as to help avoid contact of the cleaning solution 114 with the thin film material 14 on the facing surface 11 (e.g., the deposition surface) of the substrate 10. However, any other configuration can instead be utilized to apply the cleaning solution 114 to the cleaning wheels 202, 204.

In an alternative embodiment, the method of cleaning a side edge of a thin film photovoltaic substrate can include spraying a cleaning solution onto the perimeter area of the facing surface of the substrate, drawing the cleaning solution to the side edge by utilizing a suction force (e.g., a vacuum pump), and allowing the cleaning solution to clean the side edge via capillary movement of the cleaning solution from the perimeter area to the side edge.

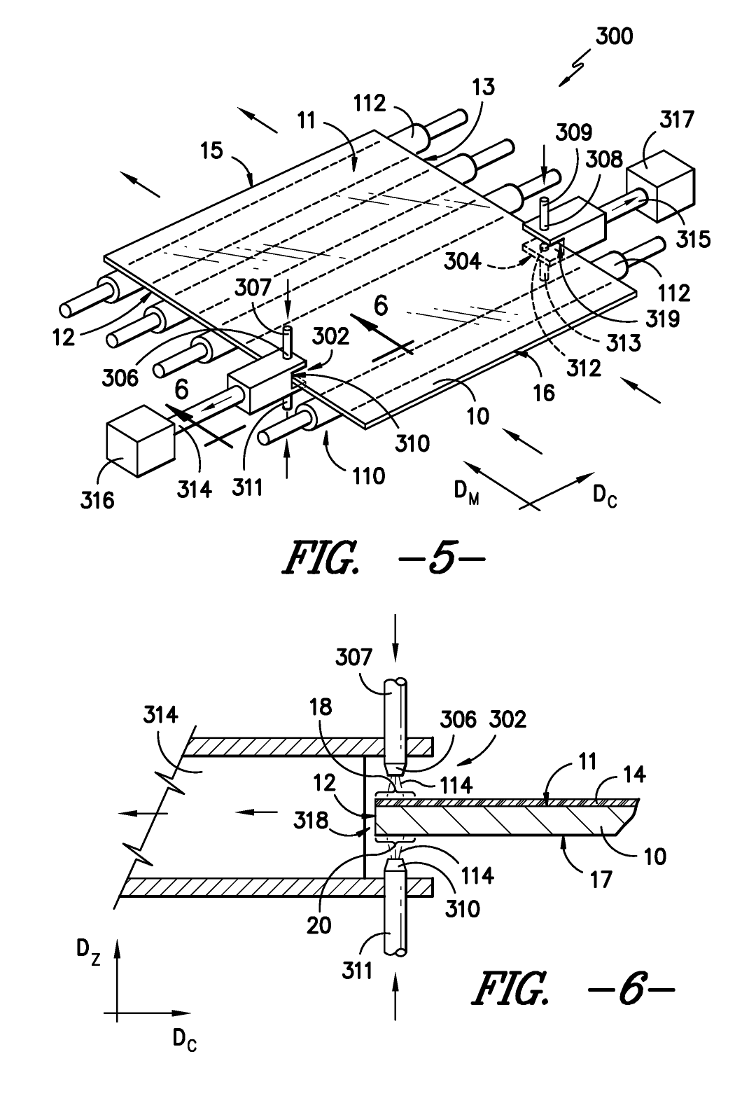

FIGS. 5-6 show an exemplary apparatus 300 for cleaning the respective side edges 12, 13 of a thin film photovoltaic substrate 10 using a spraying apparatus and suction forces. As shown, a first bracket 302 is positioned opposite of a second bracket 304 in the apparatus 300. As shown, each bracket 302, 304 defines a bracket for receiving the side edges 12, 13 therein. A transport mechanism 110 that includes a series of rollers 112 is configured to move the substrate 10 in the machine direction Dₘ between the first bracket 302 and the second bracket 304. The first and second brackets 302, 304 are positioned relative to each other such that the substrate 10 passes therebetween with its first side edge 12 extending within the first bracket 302 and its second side edge 13 extending within the second bracket 304.

Each of the first and second brackets 302, 304 include, respectively, a top spray nozzle 306, 308 and a bottom spray nozzle 310, 312. A top supply line 307, 309 is connected to the top spray nozzles 306, 308, respectively, and is configured to supply the cleaning solution 114 to the top spray nozzles 306,308. Likewise, a bottom supply line 311, 313 is connected to the bottom spray nozzles 310, 312, respectively, and is configured to supply the cleaning solution 114 to the bottom spray nozzles 310,312.

As shown in more detail in FIG. 6 with respect to the first bracket 302, the top nozzle 306 sprays the cleaning solution 114 onto the top side portion 18 of the facing surface 13. Simultaneously, the bottom nozzle 310 sprays the cleaning solution 114 onto the bottom side portion 20 of the back surface 17 of the substrate 10. A suctioning force can be applied to the side edge 12 via the vacuum line 314 connected to an evacuation opening 318 in the first bracket 302 between the top spray nozzle 306 and the bottom spray nozzle 310. The vacuum line 314 is, in turn, connected to a vacuum pump 316 and is thereby configured to draw the cleaning solution 114 to the first side edge 12 of the substrate 10 after the cleaning solution 114 is sprayed from the top spray nozzle 306 and the bottom spray nozzle 308. As may be readily understood, this embodiment, in particular, could be used to facilitate both an edge delete on the deposition surface 11 and the cleaning of the side edges 12, 13.

Similarly, as shown in FIG. 5, the second bracket 304 also has a vacuum line 315 connected to an evacuation opening 319 in the second bracket 304 between the top spray nozzle 308 and the bottom spray nozzle 312. The vacuum line 315 is connected to a vacuum pump 317 and is configured to draw the cleaning solution 114 to the second side edge 13 of the substrate 10 after the cleaning solution 114 is sprayed from the top spray nozzle 308 and the bottom spray nozzle 312.

As such, the cleaning solution 114 can remove any thin film material on the side edges 12, 13 of the substrate 10.

Even though the cleaning solution 114 contacts top side portion 18 where the thin film layer 14 is present on the facing surface 11 of the substrate, the performance of the resulting device can be unaltered since the top side portion 18 is within an edge delete zone of the facing surface 11. For example, the top side portion 18 can be less than 10 mm from the side edge 12 (e.g., about 1 mm to about 5 mm). As alluded to above, in one embodiment, both a complete edge delete and a side edge cleaning can be achieved using such an apparatus 300, if sufficiently controlled.

In one embodiment, the substrate 10 can be rotated 90° and then re-run through the apparatus 100, 200, or 300 (or through another apparatus 100, 200, or 300), in order to remove any thin film material 14 from the leading edge 15 and trailing edge 16. Thus, all four edges 12, 13, 15, 16 can be cleaned for further processing.

The cleaning solution 114 can be selected based upon the composition of the thin film material present on the side edge of the substrate. For instance, when the thin film material includes cadmium telluride, the cleaning solution can include, but are not limited to, nitric acid, hydrochloric acid, hydrofluoric acid, sulfuric acid, hydrogen peroxide, sodium hydroxide, sodium hydrosulfate, deionized water, or combinations thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of cleaning a side edge of a thin film photovoltaic substrate, wherein the substrate defines a face surface terminating at a side edge, and wherein a thin film is present on the face surface of the substrate, the method comprising:
applying a cleaning solution to a cleaning wheel, wherein the cleaning wheel defines a cleaning surface, and wherein the cleaning wheel is rotatable about an axis;
transporting the substrate in a machine direction to move the substrate past the cleaning wheel; and,
contacting the cleaning surface of the cleaning wheel with the side edge of the substrate such that any thin film present on the side edge of the substrate is removed.

2. The method as in claim 1, wherein the cleaning wheel rotates about the axis independent of the movement of the substrate such that the cleaning surface rubs the side edge of the substrate.

3. The method as in claim 1, wherein applying the cleaning solution to the cleaning wheel comprises rotating the cleaning wheel through a solution bath.

4. The method as in claim 1, wherein applying the cleaning solution to the cleaning wheel comprises spraying the cleaning solution onto the cleaning wheel.

5. The method as in claim 1, wherein the axis of the cleaning wheel is oriented in a cross-machine direction such that the cleaning surface is oriented parallel to the side edge of the substrate.

6. The method as in claim 5, wherein the cleaning wheel has a disk shape having an outer ring, the cleaning wheel being oriented such that the side edge of the substrate contacts the cleaning surface.

7. The method as in claim 1, wherein the axis of the cleaning wheel is oriented in a z-direction that is perpendicular to the machine direction.

8. The method as in claim 7, wherein the cleaning surface is positioned within a groove between a top ring and a bottom ring such that the side edge of the substrate fits therebetween to contact the cleaning surface.

9. The method as in claim 1, wherein the substrate defines a second side edge, the method further comprising:
applying the cleaning solution to a second cleaning wheel, wherein the second cleaning wheel defines a second cleaning surface, and wherein the second cleaning wheel is rotatable about a second axis;
transporting the substrate in a machine direction to move the substrate past the second cleaning wheel; and,
contacting the second cleaning surface of the second cleaning wheel with the second side edge of the substrate such that any thin film present on the second side edge of the substrate is removed.

10. The method as in claim 1, wherein the thin film comprises cadmium telluride, and wherein the cleaning solution comprises nitric acid.

11. An apparatus for cleaning a side edge of a thin film photovoltaic substrate, the apparatus comprising:
a cleaning wheel rotatable about an axis, wherein the cleaning wheel defines a cleaning surface;
a source of a cleaning solution configured to apply the cleaning solution onto the cleaning surface of the cleaning wheel; and,
a transport mechanism configured to move the substrate in a machine direction past the cleaning wheel such that the cleaning surface of the cleaning wheel contacts the side edge of the substrate to remove any thin film present on the side edge of the substrate.

12. The apparatus as in claim 11, further comprising:
a motor configured to rotate the cleaning wheel about the axis independent of the movement of the substrate such that the cleaning surface rubs the side edge of the substrate.

13. The apparatus as in claim 11, further comprising:
a solution bath positioned with respect to the cleaning wheel such that a portion of the cleaning wheel submerges in the solution bath

14. The apparatus as in claim 11, wherein the source further comprises a delivery nozzle configured to spray the cleaning solution onto the cleaning wheel.

15. The apparatus as in claim 11, wherein the axis of the cleaning wheel is oriented in a cross-machine direction such that the cleaning surface is oriented perpendicular to the side edge of the substrate.

16. The apparatus as in claim 15, wherein the cleaning wheel defines a disk having a first side surface and an outer ring, the first side surface defining the cleaning surface of the cleaning wheel, and wherein the first side surface is oriented such that the side edge of the substrate contacts the first side surface.

17. The apparatus as in claim 11, wherein the axis of the cleaning wheel is oriented in a z-direction that is perpendicular to the machine direction.

18. The apparatus as in claim 17, wherein the cleaning wheel defines a groove, and wherein the cleaning surface is positioned within the groove such that the side edge of the substrate fits within the groove to contact the cleaning surface.

19. An apparatus for cleaning a side edge of a thin film photovoltaic substrate, the apparatus comprising:
a transport mechanism configured to move the substrate in a machine direction, wherein the substrate defines a first side edge and a second side edge;
a first bracket defining a top spray nozzle and a bottom spray nozzle, wherein the first bracket is positioned along the transport mechanism and configured to receive the first side edge between the top spray nozzle and the bottom spray nozzle;
a first supply line connected to the top spray nozzle and configured to supply a cleaning solution to the top spray nozzle;
a second supply line connected to the bottom spray nozzle and configured to supply the cleaning solution to the bottom spray nozzle; and,
a vacuum line connected to an evacuation opening in the first bracket between the top spray nozzle and the bottom spray nozzle, wherein the vacuum line is connected to a vacuum pump and is configured to draw the cleaning solution to the first side edge of the substrate after the cleaning solution is sprayed from the top spray nozzle and the bottom spray nozzle.

20. The apparatus as in claim 19, further comprising:
a second bracket defining a top spray nozzle and a bottom spray nozzle, wherein the second bracket is positioned along the transport mechanism and configured to receive the second side edge between the top spray nozzle and the bottom spray nozzle;
a third supply line connected to the top spray nozzle and configured to supply a cleaning solution to the top spray nozzle;
a fourth supply line connected to the bottom spray nozzle and configured to supply the cleaning solution to the bottom spray nozzle; and,
a second vacuum line connected to a second evacuation opening in the second bracket between the top spray nozzle and the bottom spray nozzle, wherein the second vacuum line is connected to a vacuum pump and is configured to draw the cleaning solution to the second side edge of the substrate after the cleaning solution is sprayed from the top spray nozzle and the bottom spray nozzle.
